(19) United States
(12) Patent Application Publication
(10) Pub. No.: US 2014/0063367 A1
(43) Pub. Date: Mar. 6, 2014

(54) LIQUID CRYSTAL GRATING, METHOD FOR MANUFACTURING THE SAME AND 3D DISPLAY DEVICE

(71) Applicant: BEIJING BOE OPTOELECTRONICS TECHNOLOGY CO., LTD., Beijing (CN)

(72) Inventors: Shengji Yang, Beijing (CN); Junwei Wu, Beijing (CN); Haisheng Wang, Beijing (CN)

(73) Assignee: BEIJING BOE OPTOELECTRONICS TECHNOLOGY CO., LTD., Beijing (CN)

(21) Appl. No.: 13/996,076

(22) PCT Filed: Dec. 11, 2012
(86) PCT No.: PCT/CN2012/086342

§ 371 Date: Jun. 20, 2013

(30) Foreign Application Priority Data
May 3, 2012 (CN) 201210135675.8

(51) Int. Cl. G02F 1/1335; G02B 27/22

(52) U.S. Cl. CPC G02F 1/1335; G02B 27/22
USPC 349/12; 349/58; 349/15; 29/846

(57) ABSTRACT

There are provided a liquid crystal grating, a manufacturing method thereof and a 3D display device. The manufacturing method comprises: producing a conductive layer (808) and an alignment mark (812) on a top surface of an upper surface (801) in accordance with a first preset pattern; producing a first insulating layer (809), a touch control electrode layer (810) and a second insulating layer (811) on the conductive layer (808) in sequence; producing a plane electrode (805) which is grounded on a bottom surface of the upper substrate (801) which is opposite to the top surface; cell-assembling the upper substrate (801) and a lower substrate (802) in accordance with the alignment mark (812) so as to form the liquid crystal grating, wherein there are strip-like electrodes (806) on a top surface of the lower substrate (802), and the bottom surface of the upper substrate (801) with the plane electrode (805) formed faces the top surface of the lower substrate (801).

### BACKGROUND

Embodiments of the present invention relate to a liquid crystal grating, a method for manufacturing the same and a 3D display device.

Currently, products having both a 3D display function and a touch control function get more and more attention. However, in prior art, both functions are mostly combined in a simple manner, and thus many problems occur.

FIG. 1 is a schematic view showing an existing structure of a 3D grating plus an add-on touch control screen, wherein a display unit 1 and a 3D unit 2 and a touch control unit 3 which are added to the display unit 1 are illustrated. The 3D unit 2 includes an upper substrate 22 and a lower substrate 23 which are bonded by an adhesive frame 21, liquid crystal 24 located between the upper substrate 22 and the lower substrate 23, strip-like electrodes 25 located on a bottom surface of the upper substrate 22 which is opposed to the lower substrate and a plane electrode 26 located on a top surface of the lower substrate 23 which is opposed to the upper substrate. The touch control unit 3 includes a conductive layer, a first insulating layer, a touch control electrode layer, a second insulating layer and a protective layer (not shown in FIG. 1).

Such a structure suffers from the following problems:

1. If the 3D unit 2 and the touch control unit 3 are combined together simply and mechanically, namely, a module of an add-on touch control screen plus a 3D display is adopted, this will lead to a complex manufacturing process, a high production cost and other problems, and moreover, the whole module has a larger thickness, and this also necessarily affect the 3D display effect.

2. When the structure shown in FIG. 1 is adopted, there is larger signal interference between the touch control unit 3 and the 3D unit 2. FIG. 2 is a schematic view showing the position of a touch control electrode layer 31 in the touch control unit 3 and strip-like electrodes 25 and the plane electrode 26 in the 3D unit 2. When the strip-like electrodes 25 are grounded and an alternating current is transmitted through the plane electrode 26, as in a peripheral circuitry of the upper substrate 22, the current of the plane electrode 26 is transmitted through a conductive adhesive TR outside the adhesive frame 21, and there is an overlapping portion between a peripheral wiring and the touch control electrode layer 31 in a vertical direction, the alternating current in the plane electrode 26 causes a signal interference to the touch control unit 3. Conversely, when an alternating current is transmitted through the strip-like electrodes 25 and the plane electrode 26 is grounded, as there is an overlapping portion between the strip-like electrodes 25 and the touch control electrode layer 31 in the vertical direction, the alternating current in the strip-like electrodes 25 causes a severe signal interference to the touch control unit 3.

3. In prior art, a Flexible Printed Circuit board (FPC) bonding area of the touch control unit 3 is suspended (as denoted by a broken-line circle in FIG. 1), so that bonding of the FPC is not easy.

Hereinafter, a process for manufacturing the structure of the 3D grating plus the add-on touch control screen in prior art will be described in combination with accompanied drawings, and it comprises:

Step 301, an alignment mark of a metal is produced on one surface (e.g. a bottom surface) of the upper substrate;

Step 302, the upper substrate is overturned, and the conductive layer, the first insulating layer, the touch control electrode layer, the second insulating layer and the protective layer of the touch control unit are produced on another surface (i.e. a top surface) of the upper substrate;

Step 303, the upper substrate is overturned again, and a strip-like electrode layer and a bonding area for bonding of pins are produced on the surface with the alignment mark.

In teems of the process flow, upon manufacturing the structure of the 3D grating plus the add-on touch screen in prior art, if all layers of the touch control unit are produced on the top surface of the upper substrate firstly, and next, all layers of the 3D grating are produced, then in this case, gold fingers of the FPC bonding area in the touch control unit may be etched off upon formation of a metal layer of the 3D grating. Furthermore, a surface of the touch control unit contacts transport roller too much in this process, surface scratches of the touch control unit tend to occur without the use of any protective measure. If all layers of the 3D grating are produced firstly and next, all layers of the touch control unit are produced, then the upper substrate (e.g. a glass substrate) will be overturned twice (one for a manufacturing process, and one for an alignment). Because overturning of the upper substrate needs to be made by hand in prior art, not only overturning number is increased and production capacity is reduced, but also overturning by hand may cause scratches. If the metal layer of the 3D grating is firstly manufactured on the upper substrate, all layers of the touch control unit are manufactured next, and then a 3D transparent electrode layer is fabricated, it is necessary for the substrate to be overturned twice as well in the manufacturing process although overturning number of the substrate upon alignment can be decreased.

To sum up, the structure of the 3D grating plus the add-on touch screen in prior art suffers from a larger signal interference problem, and moreover, there are more times of overturning the substrate in the manufacturing process, and this inevitably brings about more scratches on the substrate.

### SUMMARY

According to embodiments of the invention, there are provided a liquid crystal grating, a manufacturing method thereof and a 3D display device, by which, it is possible that a touch control unit in the liquid crystal grating is avoided from being interfered by an electric field, and furthermore, the overturning number of an upper substrate can be decreased, and then damage to a surface of the upper substrate is reduced and production capacity is enhanced.

In an aspect, an embodiment of the invention provides a manufacturing method of a liquid crystal grating, comprising: producing a conductive layer and an alignment mark on a top surface of an upper surface in accordance with a first preset pattern; producing a first insulating layer, a touch control electrode layer and a second insulating layer on the conductive layer in sequence; producing a plane electrode which is grounded on a bottom surface of the upper substrate which is opposite to the top surface; cell-assembling the upper substrate and a lower substrate in accordance with the alignment mark so as to form the liquid crystal grating, wherein there are strip-like electrodes on a top surface of the lower substrate, and the bottom surface of the upper substrate with the plane electrode formed faces the top surface of the lower substrate.

In another aspect, an embodiment of the invention provides a liquid crystal grating, comprising: an upper substrate; a lower substrate; an adhesive frame for bonding the edge of the upper substrate and the edge of the lower substrate hermetically; liquid crystal, located in a liquid crystal space surrounded by the upper substrate, the lower substrate and the adhesive frame; a plane electrode, which is formed on a surface of the upper substrate facing the liquid crystal and is grounded; and strip-like electrodes, formed on a surface of the lower substrate facing the liquid crystal.

In still another aspect, an embodiment of the invention provides a 3D display device, comprising: a display panel; a liquid crystal grating, which is disposed on a light exiting side of the display panel, and is the liquid crystal grating claimed as any of claims 8 to 12, wherein a surface of a lower substrate of the liquid crystal grating, on which no strip-like electrode is formed, faces the display panel.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but not limitative of the invention.

FIG. 1 is a schematic view showing a structure of a 3D grating plus an add-on touch screen in prior art;

FIG. 2 is a schematic view showing the position of a touch control electrode layer of a touch control unit and strip-like electrodes and a plane electrode in a 3D unit in prior art;

FIG. 3 is a schematic view after a conductive layer of a touch control unit and an alignment mark are produced on a top surface of an upper substrate according to an embodiment of the invention;

FIG. 4a to FIG. 4h each is a schematic view showing each step of manufacturing a liquid crystal grating according to an embodiment of the invention;

FIG. 5 is a cross-sectional view showing the structure of a liquid crystal grating according to an embodiment of the invention;

FIG. 6 is a schematically cross-sectional view showing the structure of a 3D display device according to an embodiment of the invention.

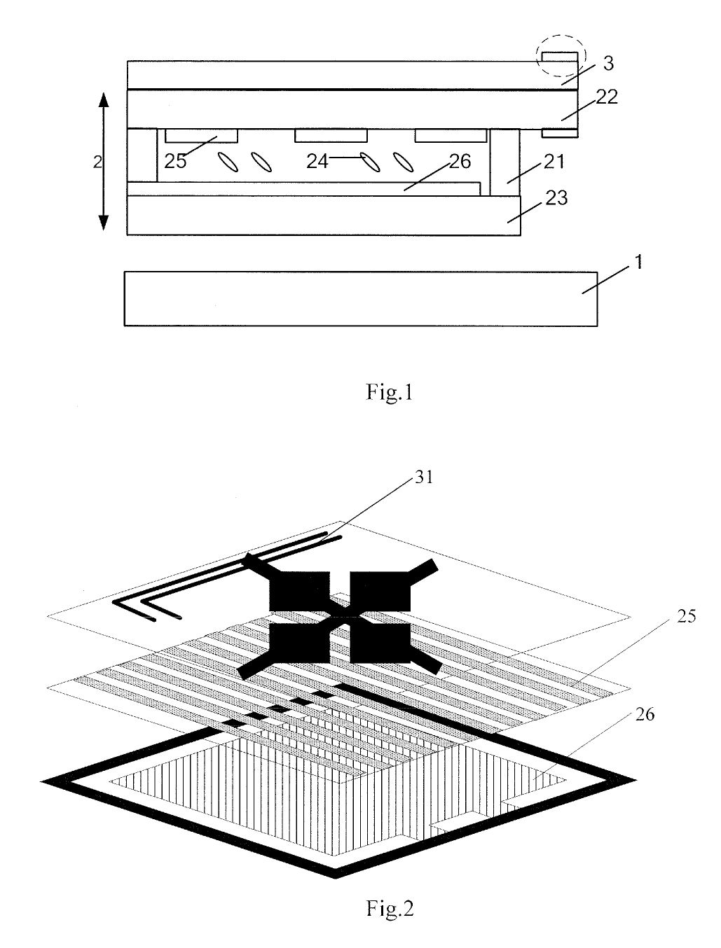

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

In order to solve a problem present in prior art, an embodiment of the invention provides a manufacturing method of a liquid crystal grating, this method comprising:

Step 401, in accordance with a first preset pattern, a conductive layer and an alignment mark are produced on a top surface of an upper surface;

Step 402, a first insulating layer, a touch control electrode layer and a second insulating layer are produced on the conductive layer in sequence;

Step 403, a plane electrode which is grounded is produced on a bottom surface of the upper substrate which is opposite to the top surface;

Step 404, the upper substrate and the lower substrate are cell-assembled in accordance with the alignment mark so as to form the liquid crystal grating, wherein, the bottom surface of the upper substrate with the plane electrode formed is opposed to a top surface of the lower substrate with strip-like electrodes formed.

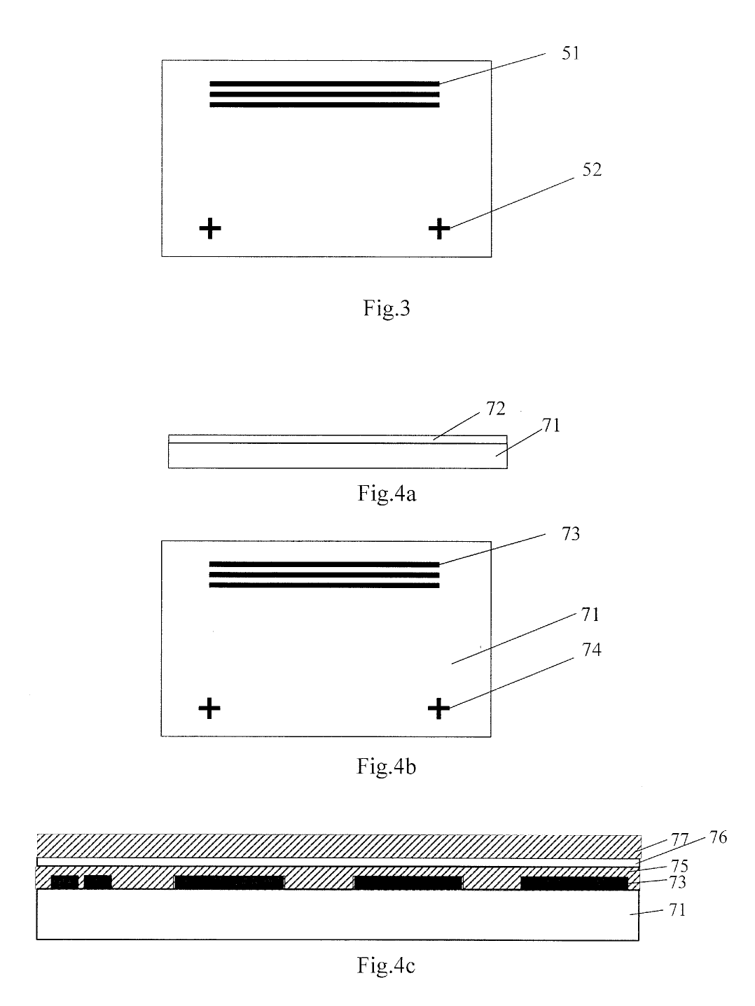

In the method provided by the embodiment of the invention, for the sake of convenience, the liquid crystal grating is used in the embodiment of the invention to replace a 3D grating plus add-on touch screen structure. In order to solve a problem present in prior art, the embodiment of the invention creatively provides the manufacturing method of the liquid crystal grating. At first, a step that, an alignment mark of a metal is produced on a bottom surface of an upper substrate in a 3D grating which is opposed to a lower substrate, is omitted in the manufacturing method according to the embodiment of the invention, but the conductive layer in a touch control unit is directly produced on the top surface of the upper substrate which is at a side opposite to the lower substrate side. Exemplarily, in accordance with the first preset pattern, the conductive layer and the alignment mark are produced simultaneously on the top surface of the upper surface through a patterning process. As shown in FIG. 3, after the top surface of the upper surface is covered with a metal, a photoresist is coated, and next, the photoresist is etched in accordance with the first preset pattern, so as to form a conductive layer 51 and an alignment mark 52 finally. Forming the conductive layer 51 and the alignment mark 52 at the same time also can decrease the number of a masking process, and the production cost is saved. Then, the first insulating layer, the touch control electrode layer and the second insulating layer are produced on the conductive layer continually, and manufacturing the touch control unit is completed.

Next, the upper substrate is overturned to make the bottom surface of the upper surface be toward top. By means of sputtering or chemical vapor deposition, the plane electrode is produced on the bottom surface. Exemplarily, the upper substrate is overturned so that a surface (the bottom surface) of the upper substrate without the touch control unit is toward top, and the plane electrode is formed on the bottom surface. When the liquid crystal grating operates, a voltage across the plane electrode is kept at zero volts, namely, a grounded voltage. As such, an impact of an electric field of a 3D control part in the liquid crystal grating on a touch control signal of the touch control unit is shielded, and in turn, a signal-to-noise ratio is improved. With the end of manufacturing the plane electrode, the upper substrate of the liquid crystal grating is basically completed.

Upon manufacturing the lower substrate, in accordance with a second preset pattern, the strip-like electrodes are produced on the top surface of the lower substrate which is opposed to the upper substrate and a connection part for a flexible circuit board is formed on the top surface of the lower substrate through a patterning process. Upon cell-assembling of the upper substrate and the lower substrate, in accordance with the alignment mark, a cell-assembling position for the upper substrate and the lower substrate is determined; with a sealant, the edge of the bottom surface of the upper substrate and the edge of the top surface of the lower substrate are sealed to form an adhesive frame; and liquid crystal is filled into a space formed by the upper substrate, the lower substrate and the adhesive frame. Wherein, after the upper substrate and the lower substrate are cell-assembled, the connection part for the flexible circuit board is located outside the space formed by the adhesive frame and the upper and lower substrates.

After the end of manufacturing the liquid crystal grating, the liquid crystal grating may be added to a liquid crystal panel. That is, the bottom surface of the lower substrate is adhered to the liquid crystal panel. For example, an Optical Clear Adhesive (OCA) may be used to adhere the lower substrate of the liquid crystal grating and edges of the liquid crystal panel together, where the liquid crystal grating is disposed on a light exiting side of the liquid crystal panel.

In addition, there is further the connection part for a FPC of the touch control unit on a top surface of the touch control unit, and the formation process of the connection part is no longer described here.

The manufacturing method of the liquid crystal grating provided by the embodiment of the invention will be described in detail below with the use of a specific example. A case that an upper substrate is processed firstly and then a lower substrate is processed is described as an example, it comprises the following steps:

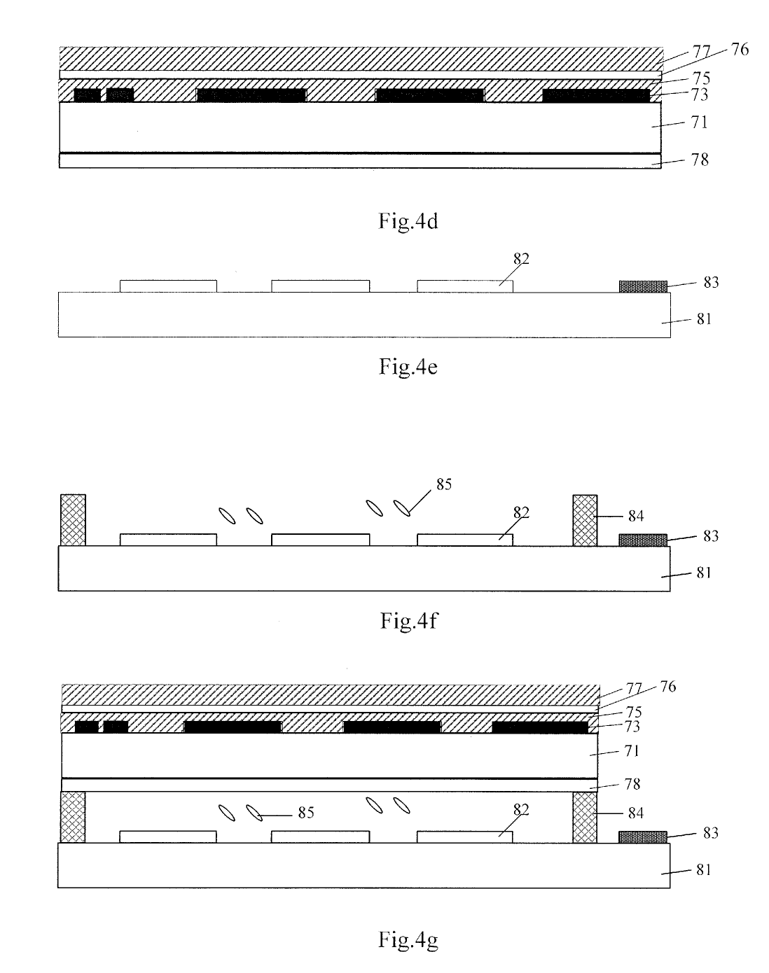

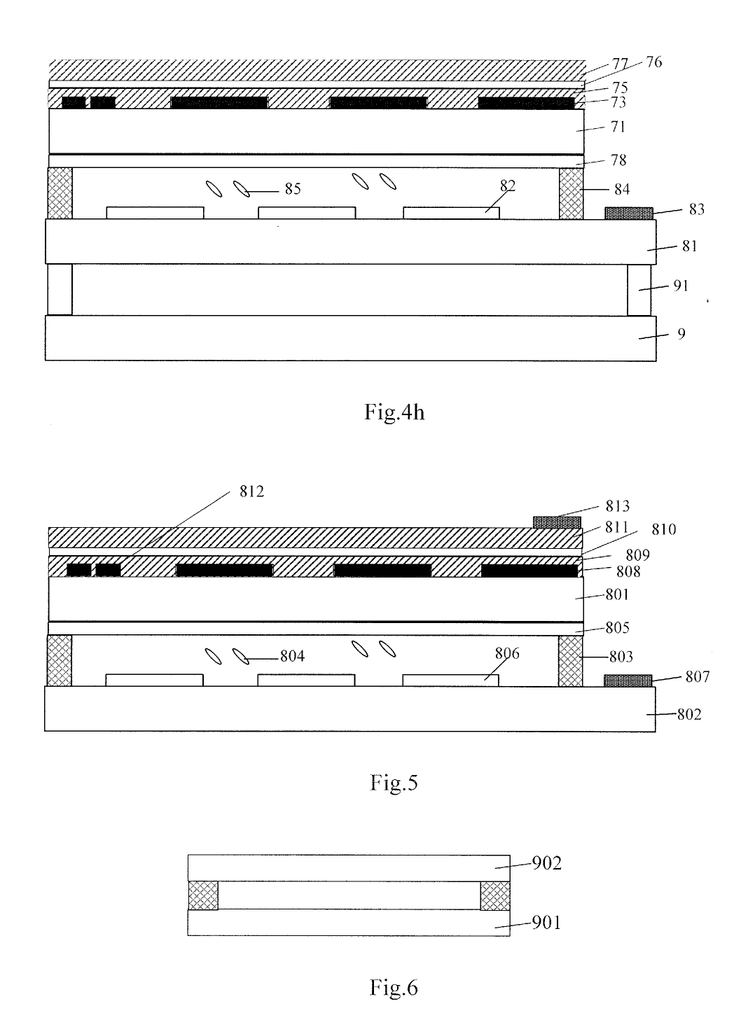

Step 601, a metal layer is formed on a top surface of the upper substrate; FIG. 4a is a cross-sectional view of the upper substrate, as shown in FIG. 4a, on an upper substrate 71, there is formed a metal layer 72. The metal layer 72 covers the whole top surface of the upper substrate 71;

Step 602, in accordance with a first preset pattern, the metal layer is etched through a patterning process, so as to form a conductive layer of a touch control unit and an alignment mark for alignment of the upper and lower substrates; as shown in FIG. 4b which is a top view showing the conductive layer of the touch control unit and the alignment mark, on the upper substrate 71, there are formed a conductive layer 73 of the touch control unit and an alignment mark 74;

Step 603, further, a first insulating layer, a touch control electrode layer, a second insulating layer and a protective layer are produced; as shown in FIG. 4c, on the basis of FIGS. 4a and 4b, a first insulating layer 75, a touch control electrode layer 76 and a second insulating layer 77 are produced in sequence. Where, upon manufacturing the touch control electrode layer 76, the first insulating layer 75 is covered with a layer of transparent conductive material (e.g. ITO) at first, and then the touch control electrode layer (also can be called as a transparent electrode layer) is formed through a patterning process in accordance with a third preset pattern;

Step 604, the upper substrate is overturned, and a layer of transparent conductive material (e.g. ITO) is uniformly sprayed on a bottom surface of the upper substrate, so as to form a plane electrode. As shown in FIG. 4d, on the basis of FIG. 4c, a plane electrode 78 is formed on the bottom surface of the upper substrate 71. So, manufacturing the upper substrate 71 of the liquid crystal grating is basically completed, and the upper substrate 71 is overturned only once during manufacturing. Additionally, when the liquid crystal grating operates normally, the plane electrode 78 is grounded and has a voltage of 0, to thereby shield an impact of an electric field of a 3D control part of the liquid crystal grating on a touch control signal of the touch control unit. In turn, a signal-to-noise ratio is improved.

Step 605, strip-like electrodes are produced on a top surface of the lower substrate, and a connection part for a flexible circuit board is formed on the top surface of the lower substrate. Exemplarily, as shown in FIG. 4e, in accordance with a second preset pattern, strip-like electrodes 82 are produced on a top surface of a lower substrate 81 through a patterning process, and a connection part 83 for a flexible circuit board is formed. After the end of manufacturing the upper substrate and the lower substrate, they are cell-assembled. Where, after cell-assembling of the upper substrate and the lower substrate, the connection part for the flexible circuit board is locate outside a space formed by an adhesive frame and the upper and lower substrates;

Step 606, a sealant 84 is provided at the edge of the lower substrate, and liquid crystal is injected within a region enclosed by the sealant; as shown in FIG. 4f, the sealant 84 is disposed at the edge of the lower substrate 81, and a liquid crystal drop region surrounded by the sealant 84 is formed on the lower substrate 81. After that, liquid crystal 85 is injected within the liquid crystal drop region;

Step 607, the relative relationship between the upper substrate and the lower substrate is determined in accordance with the alignment mark, and they are cell-assembled. As shown in FIG. 4g, the lower substrate 81, the upper substrate 71 and the adhesive frame form a closed space, and the connection part 83 for the flexible circuit board is located outside the space formed by the adhesive frame and the upper substrate 71 and the lower substrate 81.

Up to here, manufacturing the liquid crystal grating according to the embodiment of the invention is completed.

After the end of manufacture of the liquid crystal grating, the following steps may further be used to assemble the liquid crystal grating and a display panel.

Exemplarily, the description will be given to an example in which a liquid crystal panel functions as the display panel.

Step 608, the liquid crystal grating is added to the liquid crystal panel, where the liquid crystal grating is disposed on a light exiting side of the liquid crystal panel. As shown in FIG. 4h, the lower substrate 81 in the liquid crystal grating is bonded to the edge of a liquid crystal panel 9 with an OCA 91.

Optionally, the display panel may also be a plasma display panel, an organic electroluminescence (OLED) display panel, an electronic ink display panel, or the like. If the display panel is a display panel of any other type, its setting method is the same as Step 608, and details are omitted here.

As can be seen from the above descriptions, with the use of the manufacturing method of the liquid crystal grating provided by the embodiment of the invention, the plane electrode formed on the bottom surface of the upper substrate in the liquid crystal grating is grounded, and a signal interference between the 3D control part and the touch control part is shielded. Furthermore, because the alignment mark is produced while the conductive layer of the touch control part is manufactured, overturning number of the substrate is decreased, and in turn, scratch, abrasion and so on of a substrate surface is reduced. In addition, the conductive layer and the alignment mark are formed at the same time, and thus the number of mask exposure is decreased, and the production cost is saved.

Based on the same inventive concept, according to an embodiment of the invention, there is further provided a liquid crystal grating, which is produced by using the above manufacturing method of the liquid crystal grating.

As shown in FIG. 5, the liquid crystal grating provided by the embodiment of the invention comprises: an upper substrate 801; a lower substrate 802; an adhesive frame 803 for bonding the edge of the upper substrate 801 and the lower substrate 802 hermetically; liquid crystal 804, located in a liquid crystal space surrounded by the upper substrate 801, the lower substrate 802 and the adhesive frame 803.

It further comprises:

a plane electrode 805, which is formed on a surface of the upper substrate 801 facing the liquid crystal 804 and is grounded; and

strip-like electrodes 806, formed on a surface of the lower substrate 802 facing the liquid crystal 804.

Optionally, the liquid crystal grating further includes: a connection part 807 for a flexible circuit board, which is located on the surface of the lower substrate 802 facing the liquid crystal 804 and located outside a space in which the liquid crystal 804 is located.

Optionally, the liquid crystal grating further includes: a touch control unit, which is located on a surface of the upper substrate 801 apart from the liquid crystal 804. The touch control unit includes a conductive layer 808, a first insulating layer 809, a touch control electrode layer 810 and a second insulating layer 811, where, the touch control unit further includes an alignment mark 812 formed simultaneously with the conductive layer 808.

Additionally, on a top surface of the second insulating layer 811 of the touch control unit, there may be a flexible-circuit-board connection part 813 of a FPC of the touch control unit. The manufacturing process of the flexible-circuit-board connection part 813 adopts a manner well-known by those skilled in the art, and details are omitted here.

Based on the same inventive concept, according to an embodiment of the invention, there is further provided a 3D display device. As shown in FIG. 6, it comprises: a display panel 901; and a liquid crystal grating 902, which is disposed on a light exiting side of the display panel. The liquid crystal grating 902 is the liquid crystal grating provided by embodiments of the invention, wherein a surface of a lower substrate of the liquid crystal grating with strip-like electrodes formed, which is not the surface on which the strip-like electrodes are formed, faces the display panel 901.

An example of the display panel 901 is a liquid crystal panel, in which, a TFT array substrate and a counter substrate are disposed opposite to each other so as to form a liquid crystal cell, and a liquid crystal material is filled in the liquid crystal cell. The counter substrate is such as a color filter substrate. A pixel electrode of each pixel unit of the TFT array substrate acts to apply an electric field for controlling the degree of rotation of the liquid crystal material, so that display operation is conducted. In some examples, the liquid crystal panel further includes a backlight source for providing the array substrate with backlight.

Another example of the display panel is an organic electroluminescence display device, in which, a pixel electrode of each pixel unit of a TFT array substrate functions as an anode or a cathode for driving an organic light emitting material to emit light, so that display operation is conducted.

The liquid crystal grating, the manufacturing method thereof and the 3D display device provided by embodiments of the invention, the conductive layer and the alignment mark are produced on the top surface of the upper substrate in accordance with the first preset pattern; the first insulating layer, the touch control electrode layer and the second insulating layer are produced on the conductive layer in sequence; the plane electrode which is grounded is produced on the bottom surface of the lower substrate; and the upper substrate and the lower substrate are cell-assembled in accordance with the alignment mark, so as to form the liquid crystal grating, wherein, on the top surface of the lower substrate which is opposed to the upper substrate, there are strip-like electrodes. Because the plane electrode formed on the bottom surface of the upper substrate in the liquid crystal grating is grounded, signal interference between the 3D control part in the liquid crystal grating and the touch control part is shielded. Furthermore, because the alignment mark is produced while the conductive layer of the touch control part is manufactured, overturning number of the substrate is decreased, and in turn, scratch, abrasion and so on of a substrate surface is reduced. In addition, the conductive layer and the alignment mark are formed at the same time, and thus the number of mask exposure can also be decreased, and the production cost is saved.

It should be understood by those skilled in the art that various changes and modifications may be made in these embodiments without departing from the scope and spirit of the present invention. If these changes and modifications fall into the range of the claims and their equivalents, the present invention also is directed to include these changes and modifications.

1. A manufacturing method of a liquid crystal grating, comprising:
producing a conductive layer and an alignment mark on a top surface of an upper surface in accordance with a first preset pattern;
producing a first insulating layer, a touch control electrode layer and a second insulating layer on the conductive layer in sequence;
producing a plane electrode which is grounded on a bottom surface of the upper substrate which is opposite to the top surface;
cell-assembling the upper substrate and a lower substrate in accordance with the alignment mark so as to form the liquid crystal grating, wherein there are strip-like electrodes on a top surface of the lower substrate, and the bottom surface of the upper substrate with the plane electrode formed faces the top surface of the lower substrate.

2. The manufacturing method claimed as claim 1, wherein the producing the conductive layer and the alignment mark on the top surface of the upper surface in accordance with the first preset pattern includes:
producing the conductive layer and the alignment mark on the top surface of the upper surface by a patterning process in accordance with the first preset pattern at the same time.

3. The manufacturing method claimed as claim 1, wherein the producing the plane electrode which is grounded on the bottom surface of the upper substrate which is opposite to the top surface includes:
overturning the upper substrate, so that the bottom surface of the upper substrate is toward top;
by means of sputtering or chemical vapor deposition, forming the plane electrode on the bottom surface.

4. The manufacturing method claimed as claim 1, wherein the cell-assembling the upper substrate and the lower substrate in accordance with the alignment mark so as to form the liquid crystal grating includes:
determining a relative position for cell-assembling of the upper substrate and the lower substrate in accordance with the alignment mark;
sealing the edge of the bottom surface of the upper substrate and the edge of the top surface of the lower substrate with a sealant, so as to form an adhesive frame;
filling liquid crystal into a space formed by the upper substrate, the lower substrate and the adhesive frame.

5. The manufacturing method claimed as claim 4, further comprising:
producing the strip-like electrodes on the top surface of the lower substrate through a patterning process in accordance with a second preset pattern;
forming a connection part for a flexible circuit board on the top surface of the lower substrate,
wherein after the upper substrate and the lower substrate is cell-assembled, the connection part for the flexible circuit board is located outside a space formed by the adhesive frame and the upper substrate and the lower substrate.

6. The manufacturing method claimed as claim 1, wherein the producing the conductive layer and the alignment mark on the top surface of the upper surface in accordance with the first preset pattern includes:
forming a metal layer on the top surface of the upper substrate so that the metal layer covers the whole top surface of the upper substrate;
etching the metal layer through a patterning process in accordance with the first preset pattern, so as to produce the conductive layer and the alignment mark on the top surface of the upper substrate.

7. The manufacturing method claimed as claim 1, wherein the producing the touch control electrode layer on the conductive layer includes:
covering the first insulating layer with a layer of transparent conductive material; and
forming the touch control electrode layer through a patterning process in accordance with a third preset pattern.

8. A liquid crystal grating, manufactured by using the method of claim 1 and comprising:
an upper substrate;
a lower substrate;
an adhesive frame for bonding the edge of the upper substrate and the edge of the lower substrate hermetically;
liquid crystal, located in a liquid crystal space surrounded by the upper substrate, the lower substrate and the adhesive frame;
a plane electrode, which is formed on a surface of the upper substrate facing the liquid crystal and is grounded; and
strip-like electrodes, formed on a surface of the lower substrate facing the liquid crystal.

9. The liquid crystal grating claimed claim 8, further comprising:
a connection part for a flexible circuit board, which is located on the surface of the lower substrate facing the liquid crystal and located outside the liquid crystal space.

10. The liquid crystal grating claimed claim 8, further comprising:
a touch control unit, formed on a surface of the upper substrate apart from the liquid crystal, wherein, from the surface of the upper substrate, the touch control unit includes a conductive layer, a first insulating layer, a touch control electrode layer and a second insulating layer in sequence.

11. The liquid crystal grating claimed claim 10, further comprising:
an alignment mark, which is coplanar with the conductive layer of the touch control unit and is formed on the surface of the upper substrate apart from the liquid crystal with the same patterning process simultaneously.

12. The liquid crystal grating claimed claim 10, further comprising: a connection part of a flexible circuit board for the touch control unit, which is formed on a surface of the second insulating layer of the touch control unit.

13. A 3D display device, comprising:
a display panel;
a liquid crystal grating, which is disposed on a light exiting side of the display panel, and is the liquid crystal grating claimed as claim 8, wherein a surface of a lower substrate of the liquid crystal grating, on which no strip-like electrode is formed, faces the display panel.

14. The 3D display device claimed as claim 13, wherein the display panel and the liquid crystal grating are bonded by an optical clear adhesive.

15. The 3D display device claimed as claim 13, wherein the display panel is a liquid crystal panel, a plasma display panel, an organic electroluminescence display panel or an electronic ink display panel.
